(19) United States
(12) Patent Application Publication
(10) Pub. No.: US 2025/0154825 A1
(43) Pub. Date: May 15, 2025

(54) SPRING WITH A MONITORING DEVICE, SYSTEM WITH A DOOR AND THE SPRING WITH THE MONITORING DEVICE, AND METHOD THEREFOR

(71) Applicant: EFAFLEX TOR- UND SICHERHEITSSYSTEME GMBH & CO. KG, Bruckberg (DE)

(72) Inventor: Andreas STEINER, Buch am Erlbach (DE)

(73) Assignee: EFAFLEX TOR- UND SICHERHEITSSYSTEME GMBH & CO. KG, Bruckberg (DE)

(21) Appl. No.: 17/635,392

(22) PCT Filed: Nov. 24, 2020
(86) PCT No.: PCT/EP2020/083166

§ 371 Date: Feb. 15, 2022

(30) Foreign Application Priority Data
Jan. 16, 2020 (DE) 10 2020 100 932.1

(51) Int. Cl. E06B 9/62; E06B 9/68; E06B 9/82; F16F 1/12

(52) U.S. Cl. CPC E06B 9/62; E06B 9/82; F16F 1/12; E06B 2009/6818; F16F 2230/08; F16F 2230/24; F16F 2238/026

(57) ABSTRACT

A spring, in particular a spring in a weight compensation device of a door, comprising: a monitoring device, which in turn comprises the following: a sensor board provided on an oscillating portion of the spring; a sensor device provided on the sensor board for detecting at least one physical quantity of the spring when the spring vibrates/oscillates; and an evaluation device for evaluating the detected physical quantity. The evaluation device is configured such that a failure of the spring can be detected or anticipated.

The invention relates to a spring with a monitoring device, a system with a door/gate, in particular a motor-driven lifting door/gate, and the spring with the monitoring device, as well as a method for monitoring a vibration behavior of a spring.

Lifting doors are widely known in practice and have been proven for a long time. They serve as a closure for door openings of various types in the private and commercial sector and comprise a door leaf which covers a door opening and can be moved in the vertical direction from an open position into a closed position and vice versa.

As an example of a lifting door, a rolling door is known which conventionally has: a door leaf which consists of lamellae which can be bent against one another and which are guided into the closed position at the two side edges of the door opening by means of vertical guide rails; a winding shaft to which the door leaf is fastened and by means of which the door leaf is moved up into the open position and is wound up; and an electric motor drive.

For balancing the door leaf weight in a rolling door, it is known to provide weight balancing devices. These typically have springs which are under maximum prestress when the door is closed and therefore support the opening movement of the door leaf. In this way, a reduction of the required drive torques can be achieved during the actuation of such a rolling door, and, with the correct adjustment of the arrangement, an uninterrupted collapse of the door leaf in the event of a fault can be prevented.

For this purpose, the urging force of the spring is usually selected such that it exceeds the respective weight of the free door leaf length, i.e. of the door leaf section not yet moved out of the door opening, up to a desired compensation point in each case. As a result, the door leaf automatically moves to an open position when, due to a defect in the drive mechanism or due to manual unlocking, for example in the event of a power failure, there is no longer any blocking action by the drive.

For example, it is known to use torsion springs for weight compensation. These are arranged coaxially with respect to a guide device and are completely tensioned in the closed position of the door leaf and are correspondingly relaxed when the door leaf is open.

In addition, weight compensation devices of the type explained, for example, in EP 0 531 327 B1 are known. This spring typically has a helical spring as a spring, as well as a tension element fastened thereto, generally in the form of a cable, band or a chain. The lower end of the spring element is firmly connected to the floor, while its upper end is coupled by the tension element to a winding shaft arranged on the lintel side of the rolling door. In the course of the closing process of the rolling door, the tension element is wound onto this winding shaft with layers lying directly on top of one another, so that the spring element is increasingly tensioned. On the other hand, the opening movement of the door leaf is connected with an unwinding process of the tension element from the winding shaft, so that a relaxation of the spring results. The winding shaft is coupled to the drive of the rolling door.

Fast-running lifting doors are used to close high-frequency doors/gate openings, especially in commercial environments. In such cases, the door leaves are moved with large strokes, often a few meters far. Due to the frequently achieved high actuating speed of more than 2 m/s, it is usually possible to close such high-speed doors between two successive passages of a forklift truck or the like and thus to produce protection against weather influences, draft or loss of the air-conditioned atmosphere in a room.

However, the increased mechanical loading of the drive components of the door associated with the rapid door movements leads to the problem that the failure probability of the drive components increases. Thus, the tension elements, springs, bearings and holders can wear and in the worst case can tear or break, which can lead to an undesired fall of the door leaf. This creates a great safety risk.

Moreover, an opening or closing of the door or a passing of the door passage is then no longer possible. This can cause a user, such as a forwarding agent, considerable economic damage.

In order to avoid this, door devices are nowadays regularly serviced, the maintenance interval being set to be so short that a complete loss of function due to impairment by environmental influences, minor damage or wear can be virtually ruled out. However, such maintenance and manual monitoring of the door functions, in particular of the safety-relevant functions, is time-consuming and cost-intensive. In addition, the components and parts of the door that are susceptible to closing must often be replaced during maintenance, which is why components and components that do not need to be replaced are disadvantageously replaced too early if the maintenance intervals are set too short.

In view of this, a system for monitoring the quality of the door guidance is known from DE 10 2015 107 416 A1, which detects an acceleration or vibration of the door leaf during movement, i.e., during opening or closing, by means of a sensor mounted directly on a door leaf. As a result, a degree of friction between the door leaf and the door guide and/or a degree of wear of the bearing components of the door device can be determined, and consequently the operability of the door device can be monitored, so that an impairment of the freedom of movement of the door leaf can be detected at an early stage and can be eliminated in order to avoid consequential damage.

Loading of the spring as an essential component of the weight compensation device, however, takes place not only when the door leaf is moved but also when the respective end position is reached due to a pronounced post-oscillation (continued swinging) of the spring when the door leaf is at a standstill. This is associated with another risk of failure.

In this respect, the spring in the case of a door device is a critical component, the failure of which can pose a danger to people and technology.

In addition, the springs with varying spring properties are calculated and manufactured system-specifically, individually for each door, on the basis of the type, the door leaf weight, the opening and closing speed. Faulty, non-matching or changing spring properties are also a problem, since the spring properties must be precisely matched.

When further springs are used which are not provided for the specific door system, a safety risk may result from this.

A further problem is in principle also the energy supply of sensors mounted on the door leaf. Power for sensors on the door leaf is regularly supplied by means of spiral or drag cables, or by means of energy chains built into the door leaf. However, these are subject to severe mechanical aging or wear, since the movement load is high, in particular in the case of high-speed doors. In addition, the use of cables and energy chains requires a high level of design complexity, which is associated with corresponding costs.

It is an object of the invention to provide a device, a system and a method for increasing the operational reliability of a door with springs.

In this case, the further objectives may be to provide a device, a system and a method for increasing the operational reliability of a door with springs which are reliable and/or cost-effective.

The operational reliability of the door may include, in particular, the aspects of detecting wear, detecting critical damage to the door mechanism, detecting maintenance errors, and/or detecting the long-term behavior of the door mechanism.

This object is achieved by the subject matter of the independent claims. Further aspects and advantageous developments of the invention are the subject matter of the dependent claims.

According to one aspect of the invention, a spring with a monitoring device is provided, the monitoring device having the following: a sensor board provided on an oscillating portion of the spring; a sensor device provided on the sensor board for detecting at least one physical quantity of the spring when the spring oscillates; an evaluation device for evaluating the detected physical quantity, the evaluation device being set up in such a way that a failure of the spring is detected or anticipated. A sensor board can, for example, consist of the known material FR4 and have conductor tracks, soldered joints and active and/or passive components mounted thereon on one or two sides.

A spring herein generally designates an elastically deformable component which, by deformation, stores mechanical energy and is preferably suitable for forming a weight balancing device. The term “spring” may refer to either a spring element, a single spring, or a spring assembly comprising multiple single springs. The spring may have a longitudinal axis, and may react to tension and/or pressure with a restoring force. If a part of the spring is deflected from a rest position and released, a characteristic oscillation/swinging of the spring occurs, inter alia, due to the restoring force. A characteristic oscillation of the spring can denote both an oscillation of the entire spring and an oscillation of a part of the spring. A physical quantity of the spring detected during the oscillation of the spring is based on a property of the spring which, with reference to the usual definition of the basic physics, can include the spring constant D. Thus, information about a property of the spring, for example about its mechanical stability, can be obtained from the physical quantity detected in this way. The spring may be, for example, a helical spring.

Detection of a failure of the spring relates to detection of a spring rupture or another disadvantageous change in the properties of the spring. A disadvantage is a change in properties if it adversely affects the intended use of the spring. An anticipation of a failure relates to a recognition of an imminent failure before it has actually occurred. A failure can be detected or anticipated in that at least one physical quantity of the spring is detected during the oscillation of the spring by means of the sensor device and is evaluated by means of the evaluation device in such a way that a potential damage event, for example a spring break, can be predicted with a high probability before its occurrence. For example, in the case of springs having a predefined behavior, a limit or a threshold value relating to at least one physical quantity can be determined by experiments in which a failure occurs with a probability that is no longer acceptable for the normal operation of a door. In this case, the usual rules for safety devices apply in particular to (high-speed) rolling doors.

According to a development of the invention, the evaluation device is set up in such a way that it detects or anticipates the failure of the spring, in that the post-oscillation behavior of the spring is evaluated after a stressing of the spring, for example after an expansion or compression along a longitudinal axis of the spring; and the evaluation device is set up in such a way that it outputs a positive monitoring signal if the failure of the spring is anticipated or detected. The post-oscillation behavior refers to the behavior of the spring after its stress, while the term of the oscillation behavior refers quite generally to its oscillation behavior, for example also during its stress.

A positive monitoring signal refers to a signal which is suitable for indicating a failure or an imminent failure of the spring. In particular, the oscillation which occurs after the end of the stressing of the spring during the transition into the rest position, for example when the door leaf has reached an end position during a closing or opening operation, can also be referred to as the post-oscillation. An end position of the door leaf depends on the respective degree of opening and closing of the door. This can be completely or partially closed or opened. A post-oscillation of the spring can be detected on the basis of the usual (physical) characteristics of the spring during the post-oscillation. For example, a decrease in the oscillation amplitude may be detected over at least two periods (again, for example, by means of threshold values), or a correlation analysis of at least one of the detected variables/quantities may be performed. Further details on this will be explained below with reference to the figures.

According to a further development of the invention, the oscillating portion of the spring is the central region of the spring between 30% and 70% of the total length of the spring. The overall length of the spring denotes the distance between two opposite ends of the springs along a longitudinal axis of the spring. Detecting the at least one physical quantity of the spring based on an oscillation in a middle part of the spring may be advantageous with respect to detecting or anticipating spring failure.

According to a development of the invention, the at least one physical quantity is at least one of a location, a speed/velocity, an acceleration, a jerk of the sensor device and an orientation of the sensor board.

The term “location” is understood to mean the position in space and the term “orientation” to mean the orientation in space. A body can change its orientation by twisting without changing its location and vice versa.

The relationship between jerk \vec{j}(t) (cf. the classical mechanics of the concept of jerk), acceleration\vec{a}(t), speed/velocity \vec{v}(t) and location \vec{x}(t) can be mathematically described with the following equation:

$$\vec{J} ( t ) = \frac{d \vec{a} ( t )}{d t} = \frac{{d}^{2} \vec{v} ( t )}{d {t}^{2}} = \frac{{d}^{3} \vec{x} ( t )}{d {t}^{3}} \qquad ( Equation l )$$

Thus, for example, the speed is the first derivative (i.e. the change) of the position vector with respect to time, the acceleration is the first derivative of the speed vector with respect to time, and the jerk is the first derivative of the acceleration vector with respect to time.

The term “acceleration” is used here generally, i.e. also in the sense of “braking” or “decelerating”, unless the facts necessarily indicate otherwise.

If a spring breakage or other change in a property of the spring occurs, a location, a speed, an acceleration and/or a jerk of the sensor device and/or an orientation of the sensor board may change as a result, compared to a spring with “normal” properties. Thus, a failure of the spring can be detected and/or anticipated.

A means for detecting the physical quantity can be, for example, an acceleration sensor which measures the acceleration of the sensor device along a longitudinal axis of the spring. The acceleration sensor may be, for example, a piezoelectric acceleration sensor or a MEMS acceleration sensor. With such a sensor, the acceleration of the sensor device can be determined quite accurately and at a high sampling rate (for example >50 Hz).

According to a development of the invention, the evaluation device is set up to determine at least one evaluation value on the basis of the at least one detected physical quantity and to compare it with a corresponding predetermined failure threshold value or failure value range, and the monitoring device is set up to output a monitoring signal which indicates the failure when a comparison condition is satisfied. The evaluation value may also include a plurality of calculated individual values, for example, this may include an array or a number sequence of physical quantities in a program software.

Such a comparison can be carried out, for example, by means of a comparator or a digital comparison or else by means of more complex comparison methods (for example by means of a pattern comparison or by means of calculations via neural networks). A comparison condition can be, for example, that the evaluation value exceeds the predetermined failure threshold value once or for a predetermined period of time or is in the failure value range. However, depending on how the failure threshold value or failure value range is defined, the comparison condition can also be that the evaluation value falls below the predetermined failure threshold value once or a predetermined period of time or lies outside the failure value range.

An evaluation value can be, for example, an amplitude of the oscillation and/or a frequency or period duration of the oscillation and/or a duration of the post-oscillation. The evaluation value can also be a mean value of the amplitude of the oscillation after at least two door strokes in order to limit disturbing influences. The evaluation value may also include a plurality of individual values. However, possible embodiments of the invention are not limited to the evaluation values mentioned by way of example. Suitable evaluation values can be, for example, values which indicate a property of the spring. The evaluation value can also be used to detect a continued swinging/post-oscillation of the spring.

According to a further development of the invention, the sensor board further comprises: a communication device for wireless or wire-bound transmission of the at least one physical quantity and/or of a monitoring signal relating to the result of the evaluation; and a power supply device, preferably a battery with a voltage constant, for powering the sensor device and the evaluation device.

In particular in the case of a communication device for wireless communication, therefore, no cabling is required for supplying power to the monitoring device and for transmitting the monitoring signal to a second device which is separate from the monitoring device, with the result that considerable design complexity and also the risk of cable breaks are reduced.

According to a further development of the invention, the sensor board also has a memory device which contains a first serial number which can be uniquely assigned to the spring, and the evaluation device is set up to compare the first serial number with a second serial number in order to provide a control signal which indicates a match and/or a deviation of the first serial number from the second serial number. This makes it possible, for example, to ensure, as described in more detail further below, that only springs suitable for this purpose are installed in a door system. The comparison can be carried out, for example, as described above.

According to the invention, a system with a door, in particular a lifting door, is also provided, which has: a door leaf, which covers a door opening and can be moved between an open position and a closed position; a drive device for moving the door leaf between the open position (open position) and the closed position (closed position); a door control device for controlling the drive device; a spring, which is connected to the door leaf and has a monitoring device, wherein the spring is designed to generate a force which counteracts a weight force of the door leaf, wherein the force generated by the spring in the closed position is greater than in the open position; and wherein the monitoring device is designed to transmit a monitoring signal to the door control device in the event of detection or anticipation of the spring failure.

A door in the sense of the invention is a device with a movable door leaf which covers a door opening, in particular a lifting door. A door according to the invention is, for example, a roller door, in which the door leaf, which comprises a plurality of individual elements (lamellae) movably connected to one another, is guided in laterally mounted guides.

This movement of the door leaf is brought about by the drive device of the door, which has, for example, a powerful electric motor, a pneumatic lifting cylinder or a hydraulic system. Furthermore, the drive device can have further mechanical components, such as, for example, gears, belts or coupling members.

The door control device can be set up for semi-automatic or fully automatic control of the drive device. A door control device of this type has a microcomputer with control programs (software) which provide the opening and closing operation as well as various operating and/or safety routines. Alternatively, the door control device may be hard-wired.

The system with door according to the invention makes it possible, in the event of a detected or anticipated failure of the spring of the door control device, to react appropriately to the detected or anticipated failure of the spring.

An appropriate reaction can be, for example, to interrupt an operation of the door in the event of a detected or anticipated spring failure.

According to a further development of the invention, the door control device can thus be set up to switch off the drive device if the monitoring signal indicates a spring failure.

An appropriate reaction can also be, for example, to stop a door leaf from falling within a predefined period of time in the event of a detected spring break and a door leaf falling connected thereto by means of an emergency stop mechanism, for example by an engine brake and/or mechanical locking bolt being triggered by the door control device. Thus, the crash of the door is not only detected but also inhibited as quickly as possible.

A crash of the door leaf is an unwanted or unintentional movement of the door leaf. A customary direction of fall is, for example, gravitationally directed downward toward the ground.

An appropriate response may also be, for example, to modify a movement of the door leaf, for example, such that a load on the spring is reduced. For example, the acceleration limits for the movement of the door leaf can be reduced.

According to a further development of the invention, the door control device can thus be set up to control the drive device in such a way that an oscillation/swinging of the spring triggered by a movement of the door leaf and detected by means of the monitoring device, in particular a subsequent oscillation/post oscillation of the spring, is reduced as a result of an acceleration or a braking of the door leaf.

According to a further development of the invention, the system with door also has: a first serial number, which can be uniquely assigned to the spring; and a second serial number, which can be uniquely assigned to the door. The monitoring device is further adapted to compare the first serial number with the second serial number and to transmit a result of the comparison of the door control device. The door control device is set up to output an error signal and/or to switch off the drive device when, as a result of the comparison, there is a deviation of the first serial number from the second serial number.

In this way, it can be ensured that only springs are used in the door intended for use, or that the door is operated only with springs suitable for this purpose.

Moreover, a system with a door according to the invention has the advantage that a movement amplitude to which the monitoring device is subjected during the monitoring of the spring is substantially smaller than in a case where the sensor is attached directly to the door leaf. Consequently, even a power supply by means of spiral or drag cables is less problematic, since the movement load on the cables is lower.

According to the invention, a method for monitoring the vibration behavior of a spring is also provided, which comprises the following steps: Detecting the oscillation behavior of a spring with a monitoring device by means of a sensor device provided on a sensor board, wherein the sensor board is provided on an oscillating portion of the spring; detecting at least one physical quantity of the spring during oscillation of the spring; and evaluating the at least one physical quantity in such a way that a failure of the spring is detected or anticipated.

According to a development thereof, the method further comprises: Detecting the onset of post-oscillation of the spring after stressing of the spring, in particular compression or expansion/elongation; detecting the at least one physical quantity of the spring during post-oscillation of the spring; and outputting a positive monitoring signal if the failure of the spring is anticipated or detected.

According to an embodiment of the method, the at least one physical quantity is at least one of a location, a speed, an acceleration, a jerk of the sensor device, and an orientation of the sensor board.

According to a development thereof, the method further comprises: Determining an evaluation value based on the at least one detected physical quantity; comparing the determined evaluation value with a corresponding predetermined failure threshold value or failure value range; outputting the positive monitoring signal indicating the failure when a comparison condition is met.

According to a development thereof, the step of evaluating includes performing a cross-correlation of a detected vibration behavior of the detected physical quantity with a prestored vibration behavior of the detected physical quantity.

The oscillation behavior of the spring can also be evaluated, for example, with a pattern recognition or with a correlation function with respect to the detected variables/quantities. For example, the detected quantity can be correlated with an “ideal” prestored vibration behavior, for example, by means of a cross-correlation function or a wavelet transformation, wherein the result of the correlation calculation is a value representing the level or measure of similarity of the detected vibration behavior with the prestored vibration behavior.

In mathematical terms, the correlation integral as a result of the calculations is the basis for how similar the functions to be examined are. For this measure or for the correlation integral, a simple threshold value can now be provided, for example, in order to recognize that the current oscillation behavior deviates too greatly from the prestored oscillation behavior. In other words, it is possible to calculate how similar the currently detected vibration behavior is to, for example, a prestored “ideal” vibration behavior. This is an efficient method for evaluating the vibration behavior of the spring, since scanning errors, noise or even short-term deviations in the detection can be better compensated for by external disturbance quantities.

The pre-stored oscillation behavior as an input variable for the cross-correlation can advantageously be detected, for example, by means of a detection process or by means of measurements on a new or correctly functioning spring and then stored. In other words, the monitoring device can perform at least one first detection operation for detecting an initial vibration behavior of the spring by means of a calibration operation, for example, during the new installation of the door, and store the result of the detection in the memory.

The initial oscillation behavior of the spring can then be used permanently as an input for the cross-correlation function in the monitoring device, while current, or subsequent and recurring, detection processes of the oscillation behavior of the spring over the lifetime of the spring can be used as the further input for the correlation function, which is likewise carried out repeatedly. As a result of the aging of the spring over time, the result of the correlation calculation will result in a decreasing similarity of the prestored “ideal” oscillation behavior of the spring with the currently detected oscillation behavior of the spring, which can be compared, for example, with a threshold value for determining or anticipating a failure of the spring. As the oscillation behavior, for example, one of the aforementioned physical quantities, for example the detected acceleration values, can be used as a function over time, which can serve, for example, as (programming) arrays as inputs for the correlation function.

Such a method, preferably for a spring with a monitoring device according to one of the preceding aspects, can have the following steps: Detecting at least one vibration behavior of the spring during calibration; storing the vibration behavior as a first input for a correlation function; detecting at least one vibration behavior of the spring during operation of the spring or door as a second input for a correlation function; correlating the first input with the second input to determine a measure of similarity of the two inputs; optionally comparing the measure of similarity to a threshold value to determine or anticipate the failure of the spring.

The steps of detecting at least one vibration behavior of the spring during operation of the spring or the door as a second input for a correlation function; correlating the first input with the second input to determine a measure of similarity of the two inputs; and optionally comparing the measure of similarity with a threshold value for determining or anticipating the failure of the spring can preferably be performed repeatedly, while the calibration is preferably a one-time operation when the monitoring device is put into operation.

The method described above implements the same advantages as described above with respect to the spring with a monitoring device and the system with door, and is moreover more reliable.

The spring with monitoring device according to the invention and the system with door according to the invention are explained in more detail below in exemplary embodiments with reference to the figures of the drawing.

However, the embodiments and terms used herein are not intended to limit the present disclosure to certain embodiments, and they should be interpreted to include various changes, equivalents, and/or alternatives according to the embodiments of the present disclosure.

If more general terms are used in the description for features or elements illustrated in the figures, it is intended that not only the special feature or element in the figures is disclosed to the person skilled in the art, but also the more general technical teaching.

With reference to the description of the figures, the same reference numerals in the individual figures may be used to refer to similar or technically corresponding elements. Furthermore, for the sake of clarity, more elements or features can be shown with reference symbols in individual detail or detail views than in the overview views. It is to be assumed that these elements or features are also correspondingly disclosed in the overview representations, even if these are not explicitly listed there.

It is to be understood that a singular form of a noun corresponding to a matter may include one or more of the things, unless the context in question clearly indicates otherwise.

In the present disclosure, an expression such as “A or B,” “at least one of A and/or B,” or “one or more of A and/or B,” may include any possible combinations of features listed together.

For example, an expression “configured to” used in the present disclosure may be replaced by “suitable for,” “suitable to,” “adapted to,” “made to,” “capable to,” or “designed to,” as technically possible. Alternatively, in a particular situation, an expression “device configured to” may mean that the device may operate in conjunction with, or perform a corresponding function with, another device or component.

Furthermore, for the sake of clarity, not all features and elements, in particular when they are repeated, are individually designated in the figures. Rather, the elements and features are each designated by way of example. Analogous or identical elements are then to be understood as such.

In the drawings:

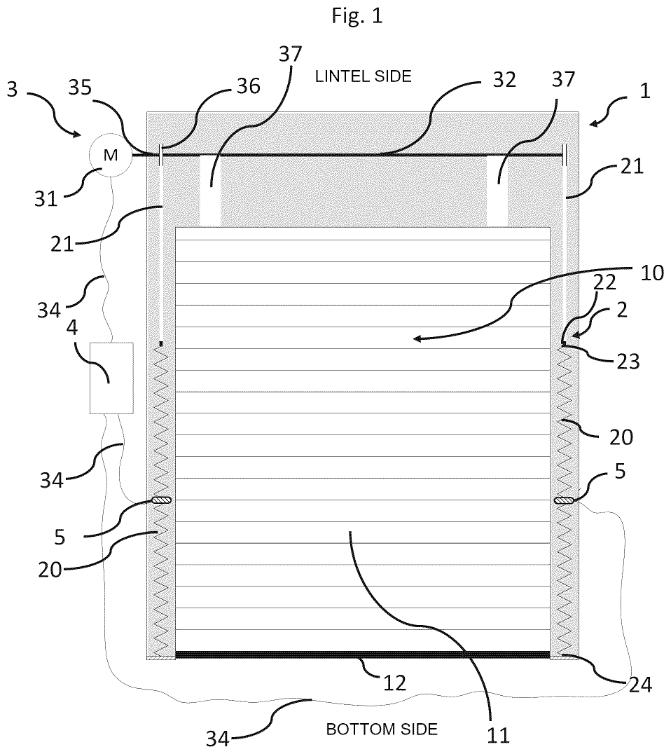

FIG. 1 is a view of a system according to the invention with door 1, drive device 3, door control device 4, weight compensation device 2, spring 20 and monitoring device 5;

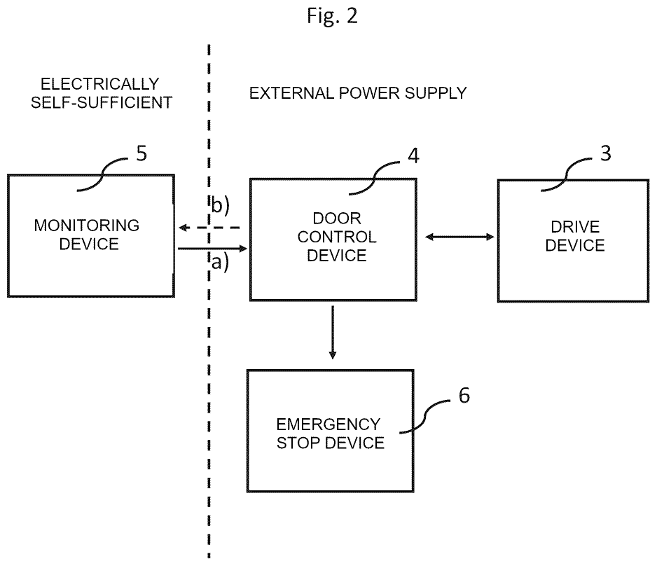

FIG. 2 is a schematic representation of a system according to the invention with door 1, drive device 3, door control device 4, monitoring device 5 and emergency stop device 6;

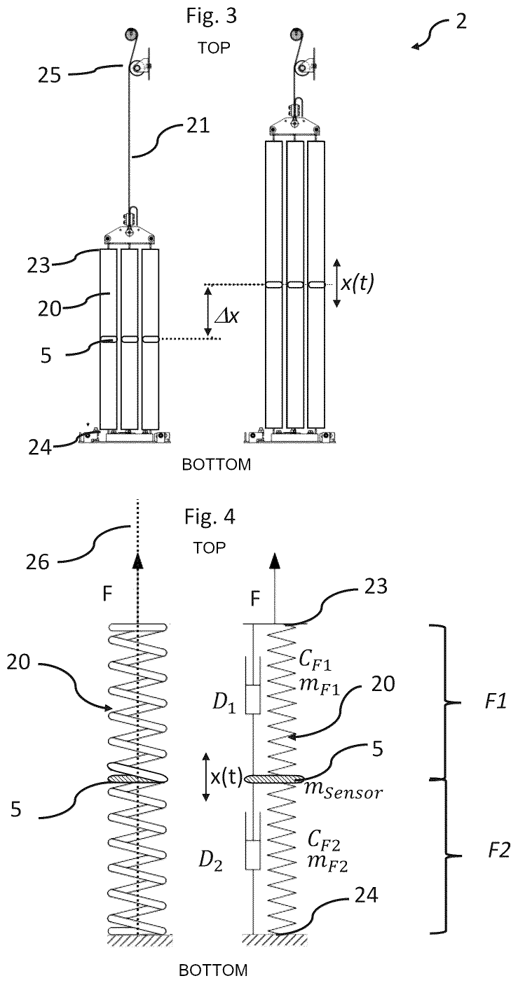

FIG. 3 is a detailed view of a weight compensation device 2 with three springs 20 and three monitoring devices 5 in two different door leaf positions (left: open position; right: closed position);

FIG. 4 left side: is a detailed view of a spring (helical spring) with a monitoring device provided thereon; right side: Replacement diagram for modeling the rebound behavior/post-oscillation behavior of the spring 20;

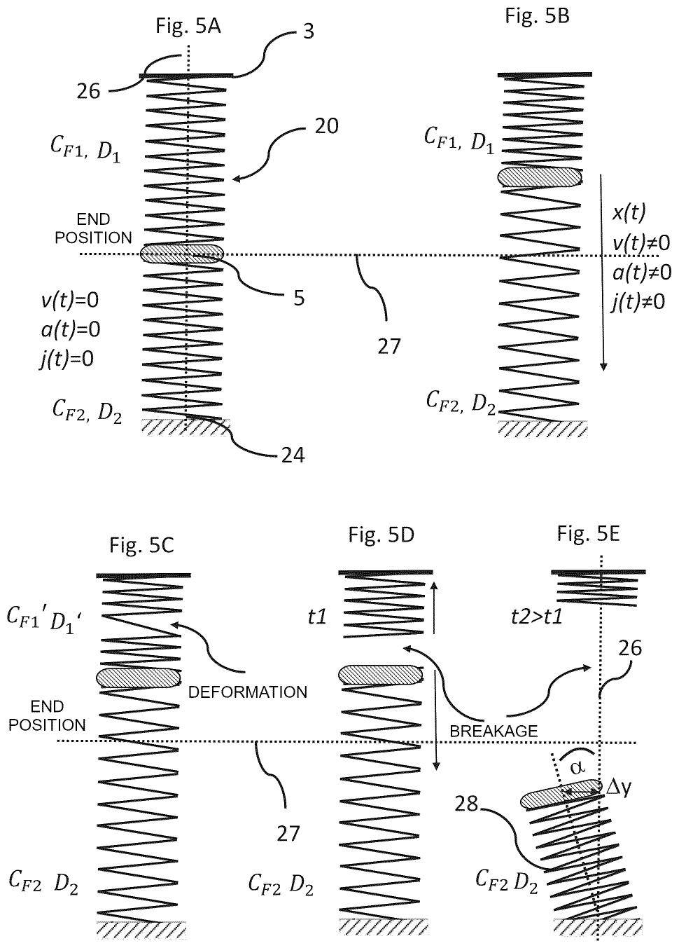

FIG. 5A is a schematic representation of an intact spring 20 with monitoring device 5 in an end position 27 (equilibrium state);

FIG. 5B is a schematic representation of an intact spring 20 with monitoring device 5 during post-oscillation (upper reversal point);

FIG. 5C is a schematic diagram of a deformed spring 20 with a monitoring device 5 during post-oscillation;

FIG. 5D is a schematic representation of a broken spring 20 with monitoring device 5 at a first time t1 after spring breakage;

FIG. 5E is a schematic representation of a broken spring 20 with monitoring device 5 at a first time t2 after spring breakage, t2>t1;

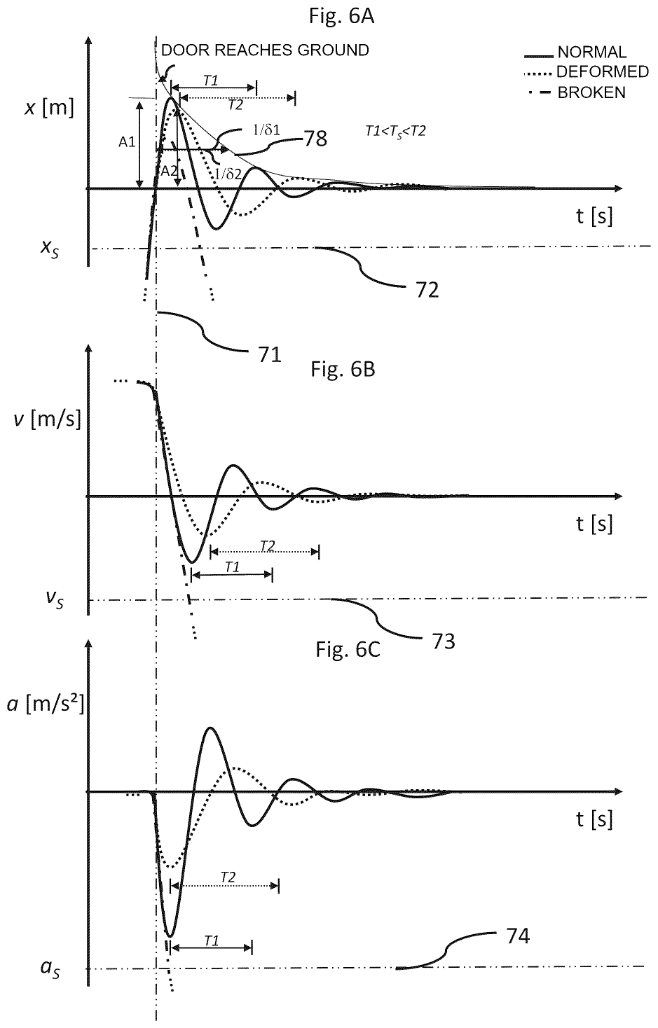

FIG. 6A schematically illustrates the location x(t) of the monitoring device 5 provided on the spring 20 during a closing operation for an intact spring (solid line), for a deformed spring (dotted line) and for a broken spring (dash-dotted line);

FIG. 6B schematically illustrates the speed v (t) of the monitoring device 5 provided on the spring 20 during a closing operation for an intact spring (solid line), for a deformed spring (dotted line), and for a broken spring (dash-dotted line);

FIG. 6C schematically illustrates the acceleration a (t) of the monitoring device 5 provided on the spring 20 during a closing operation for an intact spring (solid line), for a deformed spring (dotted line), and for a broken spring (dash-dotted line);

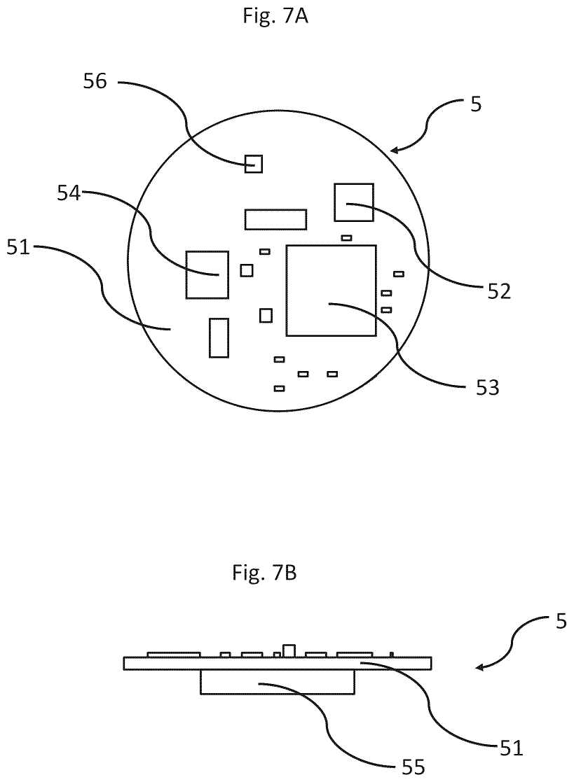

FIG. 7A is a detailed top view of a monitoring device 5 for the spring 20 according to the invention;

FIG. 7B is a detailed side view of the monitoring device 5 for the spring 20 according to the invention.

### EXEMPLARY EMBODIMENTS

FIG. 1 shows a view of a system according to the invention with a door 1, spring 20 and monitoring device 5.

The door 1 is, for example, a high-speed rolling door, in which the door leaf 10 is moved at high peak speeds, for example at more than 1 m/s, preferably at more than 2 m/s. The door leaf 10 of the door is held in lateral guides (not shown) and comprises a plurality of lamellae 11 which are coupled to one another in an articulated manner and extend perpendicularly to the guides via a door opening. Furthermore, the door leaf 10 has an end element 12 which is provided on the bottom side with a rubber seal or the like.

FIG. 1 shows the door 1, for example, in a completely closed state, in which the door leaf 10 completely covers the door opening.

The movement of the door leaf 10 between its end positions is effected by a drive device 3. The drive device 3 is controlled by the door control device 4. The drive device 3 has a motor 31, for example a powerful electric motor, which transmits the motor power by means of a drive shaft 35 in a manner known per se to a lintel-side winding shaft 32. Furthermore, the drive device 3 may have further mechanical components (not shown), such as for example gears, belts or coupling members.

The door leaf 10 is connected to the winding shaft 32 at the end in a known manner by means of one or more connecting elements 37, for example with a band, and can be wound onto the winding shaft 32 by rotating the winding shaft 32 in a winding direction. Likewise, by rotating the winding shaft 32 in an unwinding direction, the door leaf 10 can be unwound from the winding shaft 32. The winding direction is opposite to the unwinding direction. In accordance with the programming of the door control device 4, the door leaf 10 can assume any position between a completely closed and a completely open position.

The door 1 also has a weight balancing device 2. This comprises a spring 20, a tension element 21 and a guide device 36 which is mounted to the winding shaft 32.

In the present case, the spring 20 is a helical spring and is formed, for example, of a sufficiently thick wire or round steel wound in the form of a helix. The spring 20 is fastened to the bottom by its bottom end (second end 24). At its other end (first end 23), the spring 20 is fixedly connected to a pulling element 21/tension element 21, for example a metallic band, via a fastening element 22. The end of the tension element/pulling element on the end face is deflected about a deflection roller 25 (visible in FIG. 3) and is fastened to the guide device 36 in such a way that, as a result of the door leaf being unwound from the winding shaft 32 (closing operation), the pulling element 21 is wound onto the guide device 36 in overlapping positions, so that the spring 20 is increasingly tensioned and counteracts the weight of the unwound part of the door leaf 10. On the other hand, a winding of the door leaf 10 onto the winding shaft 32 (opening process) is connected with an unwinding of the tension element from the guide device 36, so that a relaxation of the spring 20 results.

The weight compensation device 2 can be set in such a way that when the door 1 is closed the spring 20 is stretched to such an extent that there is an excess moment beyond the moment produced by the force of the weight of the door leaf 10. As a result, when the closed door 1 is actuated, the door leaf 10 also moves upwards without an additional drive to approximately the height at which the weight of the free door leaf section is in equilibrium with the spring force of the spring 20 that is applied. Upon further opening of the door leaf 10, the respectively required drive torque is almost in equilibrium with the torque provided by the weight compensation device 2, so that the drive device 3 essentially only has to act against the existing frictional forces.

The spring 20 has, for example in a middle range between 30% and 70% of its total length, a monitoring device 5 according to the invention. A detailed view of the monitoring device 5 is shown in FIGS. 7A and 7B and will be described in more detail below. The monitoring device 5 is set up to detect or anticipate a failure of the spring 20 and is provided on the spring 20 in such a way that it can oscillate with the spring 20 when the spring 20 oscillates, for example during a post-oscillation of the spring 20 after a stress.

A stress occurs, for example, during a winding or unwinding process of the door leaf 10, in particular at the beginning or end of the winding or unwinding process, when the winding movement is accelerated or decelerated. A torque generated by the motor 31 and transmitted to the winding shaft 21 is transmitted to the spring 20 by the tension element, and thus, in the present exemplary embodiment, when the door leaf 10 is unwound from the winding shaft 32 (winding of the tension element onto the winding shaft), an expansion of the spring 20 can occur and, if appropriate (depending on the nature of the tension element), compression of the spring 20 can occur when the door leaf 10 is wound onto the winding shaft 32 (unwinding of the tension element 52 from the winding shaft 32). As a result of such a stress, the spring 20, and thus the monitoring device 5, oscillates.

FIG. 2 is a schematic representation of a system which comprises a door 1, a spring 20 according to the invention with a monitoring device 5, a door control device 4 and a drive device 3. As shown in FIG. 1, the monitoring device 5 is provided in or on the spring 20, for example fastened thereto. The door control device 4 is further connected to at least one emergency stop device 6. The emergency stop device 6 is used to stop the door leaf 10 in the event of a collapse of the door leaf 10, for example as a result of a spring breakage. This can be detected with the monitoring device 5 according to the invention, as will be more specifically described later. For example, locking devices can be arranged in or near the guides of the door leaf 10, and, when activated by the door control device 4, can prevent or stop a movement of the door leaf 10 in the event of a fall. In detail, for example, locking bolts or brake shoes could be used for this purpose. Alternatively, the emergency stop device 6 can also engage in the drive device 3 of the door 1 and, for example, prevent the rotation of the winding shaft 32 in a suitable manner.

The drive device 3 and the door control device 4 can be arranged in a stationary manner and adjacent to the door leaf 10. The communication between the monitoring device 5, the door control device 4 and the drive device 3 can be effected via the cable 34, as shown in FIG. 1, or wirelessly via radio.

If the communication between the monitoring device 5 and the door control device 4 is unidirectional, represented by arrow a) in FIG. 2, then the monitoring device 5 is designed with a transmitting unit and the door control device 4 is provided with a receiving unit. If the communication between the monitoring device 5 and the door control device 4 takes place bidirectionally, represented by the arrows a) and b), then both the monitoring device 5 and the door control device 4 are designed as a transmitting and receiving unit.

The signal transmission between the first and second transmitting and receiving units, an example of a wireless communication device 54, can take place via a bidirectional radio link. For example, the transmission can take place with Bluetooth. After identification of the first or second transmitting and receiving unit via the respective 48-bit address, the data transmission takes place via data packets.

Preferably, the signal transmission can take place over a unidirectional radio link. Thus, only one receiving unit is provided on the door control device 4, while only one transmitting unit (an example of a wireless communication device 40) is provided on the monitoring device 5. Thus, a unidirectional data transmission can be sufficient for certain applications. In addition, this type of data transmission is energy-saving in comparison to bidirectional data transmission, since no energy is consumed by the monitoring device 5 for the readiness to receive or for the reception of data.

Thus, in general, for a monitoring signal which consists, for example, only of a single radio signal with identification code and data field (in which a failure or anticipated failure of the spring is positively noted), only a unidirectional transmission is required. In order to ensure that the monitoring signal is actually received, it can, for example, also be repeated several times (for example twice).

The connection between the door control device 4 and the drive device 3 can take place both via the cable 34 and wirelessly, for example, as shown above, via radio. The drive device 3 drives the door leaf 10 depending on the received commands.

A plurality of further devices, such as an opening switch, a remote condition, or further sensors that detect the door opening region, may be connected to the door control device 4. The door control device 4 takes into account the information or operationally relevant parameters which are received from these further devices, and controls the drive device 3 in such a way that it opens or closes the door 1 in accordance with the desired operating mode.

FIG. 3 shows an exemplary weight compensation device 2 in an open position of the door leaf 10 (left) and a closed position of the door leaf 10 (right). The terms open position and closed position here do not necessarily denote a complete open position or closed position of the door 1. Rather, the terms are used relatively. An open position is characterized in that the door leaf 10 covers a smaller part of the door opening than in a closed position. The weight compensation device 2 shown has, for example, three springs 20 and a monitoring device 5 is provided on each spring 20. However, it is also possible to provide the weight compensation device 3 with fewer or more springs 20. The number and type of springs 20 is determined by the given loads, i.e. in particular by the type of door leaf 10, its weight and its dimensions.

As described above with reference to FIG. 1, the spring 20 is more tensioned in the closed position than in the open position. The spring 20 remains longer in a closed position than in an open position. This changes a location \vec{x}(t) (referred to only briefly as x in the text below) at which the monitoring device is located. In a closed position, for example, a location Dx at which the monitoring device is located is further away from the ground by x than in an open position. A position of the door leaf can thus be determined by detecting the x at which the monitoring device is located.

During the transition of the door leaf 10 between a closed position and an open position, a velocity/speed \vec{v}(t) (hereinafter only briefly denoted by v in the text), an acceleration \vec{a}(t) and/or a jerk (hereinafter only briefly denoted by a or j in the text) of \vec{j}(t) the monitoring device 5 change at least intermittently due to the forces acting on the spring 20. In contrast, as schematically illustrated in FIG. 5A, when the door panel 10 has reached its end position 27 or rest position and an equilibrium has been established, the speed v, the acceleration and the jerk j of the monitoring device 5 are zero. Consequently, information about the door leaf position can also be obtained from the kinetic variables, speed v, acceleration a and jerk j.

However, when the door leaf 10 stops in its end position 27, due to the intrinsic mass of the spring 20 and the intrinsic mass of the monitoring device, kinetic energy is still stored E₀ in the spring 20, and, as shown schematically in FIG. 5B, the spring 20 continues to oscillate/the spring 20 performs a post-oscillation. The post-oscillation is, on the one hand, an additional load for the spring 20 and may lead to spring wear. On the other hand, the post-oscillation receives information about the state of the spring 20 and can thus be used for spring monitoring.

For describing the vibration behavior of the spring 20 (and the monitoring device 5 provided thereon), the system can be considered as a damped spring-mass-spring system, for example as shown in FIG. 4 (right side). The movement of the monitoring device 5 along the longitudinal axis 26 is approximately a harmonically damped oscillation. The following applies:

$$x ( t ) = {x}_{0} \cdot {e}^{- δ t} \cdot ( cos ( ω \cdot t ) + \frac{δ}{ω} \cdot sin ( ω \cdot t ) ) \qquad ( Equation 2 )$$

$$with$$

$$δ = \frac{D}{2 m} \qquad ( Equation 3 )$$

$$and$$

$$ω = \frac{2 π}{T} = \sqrt{\frac{{C}_{F}}{m} - {δ}^{2}} \qquad ( Equation 4 )$$

t denotes the time,
x₀ denotes the initial, inertia-based deflection from the equilibrium position,
D denotes the damping constant of the system,
C_{F} denotes the spring rate of the system,
T denotes the period of the vibration,
δ denotes the decay constant of the vibration, and
m denotes the oscillating mass of the system.

The decay constant indicates how the amplitude of the oscillation decreases over time.

The spring constant C_{F} of the system is calculated from the spring constant C_{F1} of the first spring F1 and the spring constant C_{F2} of the second spring F2 as follows:

$$\frac{1}{{C}_{F}} = \frac{1}{{C}_{F 1}} + \frac{1}{{C}_{F 2}} \qquad ( Equation 5 )$$

For the specific case of a helical spring, the following applies to the spring constant: C_{SF}

$${C}_{S F} = \frac{G * {d}_{D}^{4}}{8 * {d}_{F}^{3} * {n}_{F}} \qquad ( Equation 6 )$$

G denotes the thrust module,
d_{D}⁴ denotes the wire diameter, d_{F}³ denotes the spring diameter, and
n_{F} denotes the number of turns.

For the oscillating mass, when m considering the mass of the spring, the point mass shall be:

$$m = \frac{1}{3} {m}_{F 1} + \frac{1}{3} {m}_{F 2} + {m}_{Sensor} \qquad ( Equation 7 )$$

m_{F1} and m_{F2} denote the mass of springs F1 and F2, and
mₛₑₙₛₒᵣ denotes the mass of the monitoring device 5.

The jerk j, the acceleration a and the speed v can be calculated according to equation 1.

If a spring constant C_{F} or a damping constant changesD, this has a direct effect on the oscillation behavior. Thus, by analyzing the vibration behavior of the spring 20, a change in a characteristic of the spring 20 may be detected, for example, a deformation of the spring 20 (as shown in FIG. 5C), or a spring break (as shown in FIGS. 5D and 5E). A deformation of the spring 20 may, for example, cause a change in characteristics to decrease the spring constant C_{F} of the system, or to increase the damping constant D of the system, and this results in a decrease in the vibration frequency ω and/or the vibration amplitude. Accordingly, a property change of the spring 20 such that the spring constant C_{F} increases or the damping constant D decreases may result in an increase in the vibration frequency ω and/or the vibration amplitude.

However, the above-mentioned parameters are not the only ones having an effect on the vibration behavior. For example, the prestressing of the spring 20 and the kinematics of the door leaf movement also have an effect on the vibration behavior.

FIG. 6A shows a schematic representation of the location x of the monitoring device 5 as a function of time t when closing the door 1 for an intact spring (solid line), for a deformed spring (dotted line) and for a broken spring (dash-dotted line). FIGS. 6B and 6C correspondingly show the speed v (t) and acceleration a (t) of the monitoring device 5. The deformation is, for example, such that the spring constant is C_{F} reduced and the damping constant remains the D same. However, other changes in the spring can also increase the spring C_{F} constant and/or D change the damping constant. The vertical dot-dash line 71 indicates the point in time at which the door leaf 10 reaches the ground and the closing process is terminated. The region to the left of it shows the final phase of a closing process in which the door leaf 10 moves downward in the direction of the floor, for example, at a substantially constant speed. In the process, the spring 20 expands and the monitoring device 5 moves upward (see also FIG. 3). To the right of this, the post-oscillation of the spring is illustrated. T1 and δ1 denote the period duration and decay constant of the oscillation of the intact spring T2 and and δ2 denote the period duration of the oscillation of the disturbed spring.

In the case of the disturbed spring, the period duration has increased in comparison with the intact spring (T2>T1). The amplitude envelopes 75 and 76 and the decay constants δ1 and δ2 for the intact and the disturbed springs are substantially the same. This is because in the present example, it was assumed that the deformation of the spring exerts only on the spring constant. In order to detect a spring failure or an imminent spring failure, it is thus possible, for example, to define a limit valueT_{S} (a failure threshold value in the sense of the invention), the exceeding of which indicates a disturbance of the spring. In other words, an evaluation value (e.g.) can thus be determined based on the detected physical quantity (e.g. ×T) and a comparison of this with the corresponding predetermined failure threshold value (e.g. Tₛ) or a failure threshold value range allows a failure of the spring 20 to be detected or anticipated. A similar procedure may also be performed based on the measured speed v, the measured acceleration a, of the measured jerk j, or a combination thereof. In another case, a limit value for the decay constant can also beds defined.

A spring rupture as shown in FIGS. 5D and 5E (it is assumed by way of example that the spring rupture is above the monitoring device 5) can cause the location of the monitoring device 5 to change to a greater extent than when an intact spring vibrates/oscillates/post-oscillates (cf. FIGS. 5 and 6A) because the monitoring device 5 is pulled toward the ground due to the lack of counterforce. Likewise, as shown in FIG. 5E, an orientation of the monitoring device 5 may change, for example, because the spring stub 28 is tilted with respect to its longitudinal axis 26, i.e., changes its position at an angle to the vertical. Due to the lack of counterforce, the monitoring device can also be subjected to a higher acceleration in the direction of the ground for a longer period of time, which in turn can lead to a higher speed. Thus, as shown in FIGS. 6A to 6C, it is also possible to determine a position limit 72, x_{S}, a speed limit 73, vs, or an acceleration limit 74, as, from which a broken spring may be distinguished from an intact spring. These limit values are also failure threshold values within the meaning of the invention.

Moreover, it is possible to use the physical quantities detected by the monitoring device 5 and the evaluation values determined therefrom in order to optimize a movement control of the door leaf 10, for example in such a way that a post-oscillation is minimized.

FIG. 7A shows a top view of an exemplary monitoring device 5 according to the invention, and FIG. 7B shows a side view thereof. The monitoring device 5 comprises: a sensor board 51, on the sensor board 51 a sensor device 52 for detecting at least one physical quantity and an evaluation device 53 for evaluating the physical quantity. The sensor device 52 has at least one sensor for detecting a location x, an orientation and/or a kinetics (e.g., speed v, acceleration a, jerk j) of the monitoring device 5, as well as optionally a signal conditioning unit (not shown). The sensor may be, for example, an acceleration sensor, for example a piezoelectric acceleration sensor or a MEMS acceleration sensor, or an acceleration sensor based on magnetic induction.

The signal conditioning unit can process, for example filter, amplify or convert the electrical signal (for example digital acceleration data) output by the sensor into absolute measured values (for example into G). In the case of a plurality of detected physical kinetic parameters, the signal conditioning unit can also multiplex the electrical signals.

The monitoring device 5 can also have a communication device 54 on the sensor board 51 for wireless transmission of the detected physical quantity and/or a monitoring signal relating to the result of an evaluation thereof. This communication device may be, for example, a radio chip with an integrated or separate antenna. In addition, the monitoring device 5 can have, for example on an underside of the sensor board 51, a power supply device 55, for example a battery with a voltage constant, for supplying power to the sensor device 52 and the evaluation device 53. Furthermore, the sensor board 51 may have a storage device 56 for storing a serial number. The serial number can be read out of the memory device 56 on request.

The evaluation device 53 can also have an arithmetic unit. In one application, the arithmetic-logic unit serves to implement the processes described in FIGS. 6A-C. For example, the computing unit can convert the data of an acceleration sensor by integration into a speed value relating to the oscillation. The computing unit can then compare this numerical speed value (an example of an evaluation value) with a predetermined speed limit value or a speed value range. If the predetermined speed limit value is exceeded (or deviated from a speed value range), the arithmetic-logic unit triggers a monitoring signal which is then transmitted to the door control device 4 immediately after the speed limit value has been exceeded, for example by means of the communication device 54. The latter can then react appropriately to the failure or the anticipated failure, for example by changing movement parameters of the door leaf movement.

The evaluation device 53 can also be set up to read out a first serial number, which can be unambiguously assigned to the spring 20, from the memory device 56 and to compare it with a second serial number, which can be unambiguously assigned to the door 1, and to provide a result of the comparison (for example in the form of a control signal) of the door control device 4, for example to transmit it by means of the communication device 54, so that the latter can react appropriately. A suitable reaction can be, for example, to output an error signal and/or to switch off the drive device 3 when, as a result of the comparison, there is a deviation of the first serial number from the second serial number.

The shape and size of the monitoring device 5 are preferably adapted to the spring 20 to be monitored. For example, the diameter of the sensor board 51 may substantially correspond to a mean coil diameter of the spring 20 and may be circular, particularly in the case of a coil spring.

The loads in the monitoring device 5 are furthermore designed in such a way that a reliable power supply is ensured. For this purpose, the electronic components in the monitoring device 5 are preferably/optionally designed in such a way that they have a very low current consumption (preferably in the μW range) and are likewise preferably supplied with current only when required. Such electronic components, for example DC-DC converters or microprocessors, are available, for example, as so-called “ultra-low-power” components.

In addition to the explained embodiments and aspects, the invention permits further design principles. Thus, individual features of the various embodiments and aspects can also be arbitrarily combined with each other as long as this can be carried out by a person skilled in the art.

The door in the system according to the invention with door, which has been explained above as a rolling door, may also be, for example, a folding door or a hinged door. Thus, according to the invention, all doors are included in which door leaves experience a defined movement or a predetermined travel path.

Furthermore, the monitoring device 5 can be accommodated on any part of the spring 20.

In principle, the monitoring device can also have further assemblies, for example low-energy display elements.

In FIG. 1, equilibrium compensation devices (or springs 20) were provided on both sides of the door opening. In particular in the case of door leaves with larger widths, this can be advantageous in order to reduce one-sided loads on the arrangement. However, the equilibrium compensation device can also be provided on only one side.

In the exemplary embodiments, the spring 20 has been described as a helical spring. In addition, it is also possible to provide other spring-elastic elements, such as, for example, stretchable bands, etc., instead of helical springs.

The tension element 21 need not be in the form of a band, but may be in the form of a chain or the like. For this purpose, a dimensionally stable material, such as, in particular, a metal, is preferred.

The guide devices 36 do not have to be mounted on the winding shaft 32, but can also be mounted on a separate bearing shaft. In particular, it is also possible that the motor 31 does not directly drive the winding shaft 32 and/or the separate bearing shaft, but indirectly via toothed belts, chains, gears, etc. However, with regard to the most compact possible arrangement, a direct drive of these components is to be preferred.

In the present exemplary embodiment, the physical quantities were detected based on an oscillation along the longitudinal direction of the spring. However, an oscillation along a direction deviating from the longitudinal direction of the spring could also be utilized.

In the exemplary embodiment shown, the evaluation device 53 is provided on the sensor board 51. However, it is also possible to provide a separate device and, for example, to provide it in the door control device 4.

The door leaf 10 shown in FIG. 1 can move from bottom to top and vice versa. However, the invention also encompasses doors whose door leaves can move in other directions, for example laterally.

The method according to the invention and the device according to the invention have been described with reference to a post-oscillation behavior of a spring and a closing of a door. However, the principle of the invention can generally be applied to spring oscillations.

### LIST OF REFERENCE NUMBERS

1 Door
10 Door leaf
11 Lamellae
12 End element
2 Weight balancing device
20 Spring
21 Tension element
22 Fastening element
23 first spring end
24 second spring end
25 Deflection pulley
26 Longitudinal axis of the spring
27 End position
28 Spring stump
3 drive device
31 Motor
32 Winding shaft
34 Cables
35 Drive shaft
36 Guiding device
37 Connecting element
4 Door control device
5 Monitoring device
51 Sensor board
52 Sensor device
53 Evaluation device
54 Communication device or unit
55 Power supply device
56 Storage device
6 Emergency stop device
71 Time when door leaf reaches the ground
72 Position limit value
73 Speed limit value
74 Acceleration limit value
75 Amplitude envelope of the intact spring
76 Amplitude envelope of the disturbed/broken spring

1. A spring comprising:
a monitoring device comprising:
a sensor board provided on an oscillating portion of the spring;
a sensor device provided on the sensor board for detecting at least one physical quantity of the spring during oscillation of the spring;
an evaluation device for evaluating the detected physical quantity,
wherein the evaluation device is configured such that a failure of the spring is detected or anticipated,
wherein the evaluation device is arranged to detect or anticipate the failure of the spring based on the post-oscillation behavior of the spring after its expansion or compression; and
wherein the evaluation device is further arranged to output a positive monitoring signal in case the failure of the spring is detected or anticipated.

2. The spring according to claim 1,
wherein the oscillating portion of the spring is a central portion of the spring between 30% and 70% of its total length.

3. The spring according to claim 1,
wherein the at least one physical quantity of the spring is at least one of the following: location, speed, acceleration, jerk of the sensor device and/or orientation of the sensor board.

4. The spring of any one according to claim 1,
wherein the evaluation device is arranged to determine an evaluation value on the basis of the at least one detected physical quantity and to compare it with a corresponding predetermined failure threshold value or failure value range, and
the monitoring device being adapted to output a monitoring signal indicating the failure when a comparison condition is met.

5. The spring according to claim 1,
wherein the sensor board further comprises a memory device including a first serial number uniquely associable with the spring, and
wherein the evaluation device is arranged to compare the first serial number with a second serial number to provide a control signal indicating a match and/or a deviation of the first serial number from the second serial number.

6. The spring according to claim 1,
wherein the sensor board further comprises:
a communication device for wireless or wired transmission of the at least one detected physical quantity and/or a monitoring signal relating to the result of the evaluation; and
a power supply device, preferably a battery with a voltage constant, for supplying power to the sensor device and the evaluation device.

7. A system comprising a door, in particular a lifting door, comprising:
a door leaf covering a door opening and movable between an open position and a closed position;
a drive device for moving the door leaf between the open position and the closed position;
a door control device for controlling the drive device;
a spring connected to the door leaf with a monitoring device according to claim 7,
wherein the spring is adapted to generate a force that counteracts a weight of the door leaf, wherein the force generated by the spring is greater in the closed position than in the open position; and
wherein the monitoring device is arranged to transmit a monitoring signal to the door control device in the event of a detection or anticipation of a spring failure.

8. The system with a door according to claim 7,
wherein the door control device is arranged to switch off the drive device when the monitoring signal indicates a spring failure.

9. The system according to claim 8, further comprising:
a first serial number uniquely associable with the spring; and
a second serial number which can be uniquely assigned to the door and/or the door leaf;
wherein the monitoring device is arranged to compare the first serial number with the second serial number and to transmit a result of the comparison of the door control device, and
wherein the door control device is arranged to output an error signal and/or to switch off the drive device when, as a result of the comparison, there is a deviation of the first serial number from the second serial number.

10. The system with a door according to claim 9,
wherein the door control device is set up to control the drive device in such a way that a vibration of the spring triggered by a movement of the door leaf and detected by means of the monitoring device, in particular a post-oscillation of the spring, due to an acceleration or a deceleration of the door leaf, is reduced.

11. A method of monitoring a vibration behavior of a spring, comprising the steps of:
detecting the vibration behavior of a spring with a monitoring device by means of a sensor device provided on a sensor board, wherein the sensor board is provided on an oscillating portion of the spring;
detecting at least one physical quantity of the spring upon oscillation of the spring; and
evaluating the at least one physical quantity in such a way that a failure of the spring is detected or anticipated;
the method further comprising:
recognition of the beginning of a post-oscillation of the spring after a stressing of the spring, in particular a compression or expansion;
detecting the at least one physical quantity of the spring upon post-oscillation of the spring; and
outputting a positive monitoring signal if the failure of the spring is detected or anticipated based on the post-oscillation behavior of the spring after its expansion or compression.

12. The method according to claim 11,
wherein the at least one physical quantity of the spring is at least one of the following: location, speed, acceleration, jerk of the sensor device and/or orientation of the sensor board.

13. The method according to claim 12, further comprising:
determining an evaluation value based on the at least one detected physical quantity;
comparing the determined evaluation value with a corresponding predetermined failure threshold or failure value range; and
outputting the positive monitoring signal indicative of the failure when a comparison condition is satisfied.

14. The method according to claim 13, wherein the step of evaluating includes performing a correlation of a detected vibration behavior of the detected physical quantity with a pre-stored vibration behavior of the detected physical quantity.

15. (canceled)

16. (canceled)
